(19) United States
(12) Patent Application Publication
(10) Pub. No.: US 2014/0111559 A1
(43) Pub. Date: Apr. 24, 2014

(54) DISPLAY APPARATUS

(71) Applicants: VTRON Technologies LTD., Guangzhou City (CN); GIO Optoelectronics Corp., Tainan City (TW)

(72) Inventors: Wu-Chang YANG, Tainan City (TW); Chin-Cheng TSAI, Tainan City (TW); Chia-Ho YANG, Tainan City (TW)

(73) Assignees: VTRON Technologies LTD., Guangzhou City (CN); GIO Optoelectronics Corp., Tainan City (TW)

(21) Appl. No.: 14/058,149

(22) Filed: Oct. 18, 2013

(30) Foreign Application Priority Data
Oct. 19, 2012 (TW) 101138623

(51) Int. Cl. G09G 5/10

(52) U.S. Cl. CPC G09G 5/10
USPC 345/690

(57) ABSTRACT

A display apparatus comprises a substrate, a plurality of scan lines, a plurality of data lines crossing the scan lines on the substrate, a plurality of light emitting units disposed in a display area of the substrate and at least a control integrated circuit (IC) chip. The control IC chip is disposed within the display area of the substrate and electrically connected to at least one of the scan lines and at least one of the data lines. The light emitting units are electrically connected to at least one of the control IC chip, which is controlled by at least one of the scan lines and receives a data signal from at least one of the data lines to control the luminous states of the light emitting units according to the data signal.

### CROSS REFERENCE TO RELATED APPLICATIONS

This Non-provisional application claims priority under 35 U.S.C. §119(a) on Patent Application No(s). 101138623 filed in Taiwan, Republic of China on Oct. 19, 2012, the entire contents of which are hereby incorporated by reference.

### BACKGROUND OF THE INVENTION

1. Field of Invention

The invention relates to a display apparatus and, in particular, to a light emitting diode (LED) display apparatus.

2. Related Art

Flat display apparatuses, having advantages such as low power consumption, less heat, light weight and non-radiation, are widely applied to various electronic products and gradually take the place of cathode ray tube (CRT) display apparatuses. Besides, the active matrix display apparatus is suitable to be applied to the large-scale and full color display of high definition and large data amount, and thus become the mainstream of the field of the display apparatus, despite the shortages such as the higher cost and more complex manufacturing processes.

Moreover, the light emitting efficiency of the light emitting diode (LED) has been increased a lot due to the continuous improvement in the manufacturing process and material. Different from other kinds of lighting sources, the LED features the less power consumption, less pollution, longer lifespan, higher safety, shorter response time and smaller size and thus has been applied to various electronic products.

The LED is used as the smallest light emitting unit (pixel) of the LED display apparatus. Generally, in an LED display apparatus, a plurality of surface-mount LEDs, each of which includes red, blue and green LED chips, are disposed on the display surface of a circuit board, and the driving control circuit is disposed on the back side of the circuit board or the edge of the display area to drive the LEDs to emit light. Besides, in the active matrix LED display apparatus, the active devices, such as transistors or capacitors, are formed by the semiconductor thin-film process (e.g. deposition process) on the circuit board.

However, the yield of the LED display apparatus may be reduced due to the factors of process, material, device characteristic or others during the thin-film process making the above-mentioned active devices. Accordingly, the production cost of the display apparatus is raised.

Therefore, it is an important subject to provide a display apparatus so that the yield can be increased and the production cost can be reduced.

### SUMMARY OF THE INVENTION

In view of the foregoing subject, an objective of the invention is to provide a display apparatus so that the yield can be increased and the production cost can be reduced.

To achieve the above objective, a display apparatus according to the invention comprises a substrate, a plurality of scan lines, a plurality of data lines crossing the scan lines on the substrate, a plurality of light emitting units disposed in a display area of the substrate and at least a control integrated circuit (IC) chip. The control IC chip is disposed within the display area of the substrate and electrically connected to at least one of the scan lines and at least one of the data lines. The light emitting units are electrically connected to at least one of the control IC chip, which is controlled by at least one of the scan lines and receives a data signal from at least one of the data lines to control the luminous states of the light emitting units according to the data signal.

In one embodiment, each of the light emitting units includes at least a light emitting diode (LED) chip.

In one embodiment, each of the LED chip and the control IC chip is disposed on the substrate by flip chip bonding or wire bonding.

In one embodiment, the number of the data lines connected to the control IC chip is less than or equal to that of the LED chips of the light emitting unit connected to the control IC chip.

In one embodiment, the number of the scan lines connected to the control IC chip is less than or equal to that of the LED chips of the light emitting unit connected to the control IC chip.

In one embodiment, the control IC chip includes a decoder, which is electrically connected to the scan lines connected to the control IC chip.

In one embodiment, the display apparatus further comprises a plurality of sensing devices electrically connected to the control IC chip.

In one embodiment, the control IC chip includes at least one sensing device.

In one embodiment, the sensing device is a photo sensing device receiving a photo signal, and the control IC chip generates a sensing signal accordingly.

In one embodiment, the photo signal is a modulation signal.

In one embodiment, the photo signal comes from an external light emitter, or comes from the light that is emitted by the display apparatus and then reflected by an external object, or comes from the light emitted by a light emitting device of the display apparatus, or comes from an external light that is blocked by an external object.

In one embodiment, the light emitting device is an LED emitting invisible light.

In one embodiment, the sensing device is an electric sensing device to receive an electric signal and the control IC chip generates a sensing signal accordingly.

In one embodiment, the electric signal comes from an external electric signal emitter, or comes from the electric signal that is emitted by the display apparatus and then coupled by an external object.

In one embodiment, the control IC chip controls the duty cycles or current levels of the light emitting units to control their luminous intensities.

In one embodiment, the data signal is an analog signal or digital signal.

As mentioned above, in the display apparatus according to the invention, the light emitting units are electrically connected to at least a control IC chip, and the control IC chip is controlled by at least a scan line and receives a data signal from at least a data line to control the luminous states of the light emitting units according to the data signal. Thereby, in comparison with the prior art, the conventional thin-film process is not used in the invention, so the display apparatus of the invention can have higher yield and less production cost.

### BRIEF DESCRIPTION OF THE DRAWINGS

The invention will become more fully understood from the detailed description and accompanying drawings, which are given for illustration only, and thus are not limitative of the present invention, and wherein:

FIG. 1A is a schematic diagram of a display apparatus according to a preferred embodiment of the invention;

FIG. 1B is a schematic diagram of the circuit of a pixel of the display apparatus in FIG. 1A;

FIG. 2A is a schematic diagram of a driving circuit of a pixel of the display apparatus as another embodiment of the invention;

FIG. 2B is a schematic diagram showing the signal in FIG. 2A;

FIG. 3A is a schematic diagram of a display apparatus according to another embodiment of the invention;

FIG. 3B is a schematic diagram showing the circuit of a pixel of the display apparatus in FIG. 3A; and

FIG. 4 is a schematic diagram of a display apparatus according to another embodiment of the invention.

### DETAILED DESCRIPTION OF THE INVENTION

The present invention will be apparent from the following detailed description, which proceeds with reference to the accompanying drawings, wherein the same references relate to the same elements.

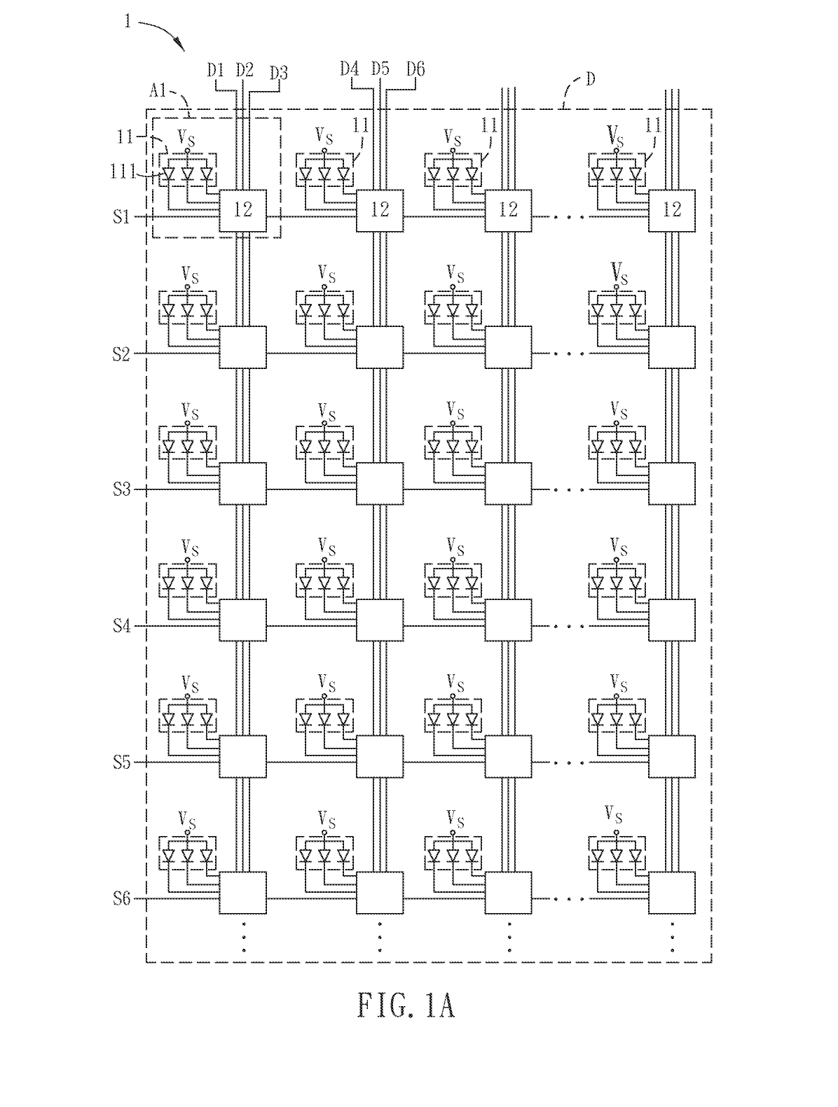

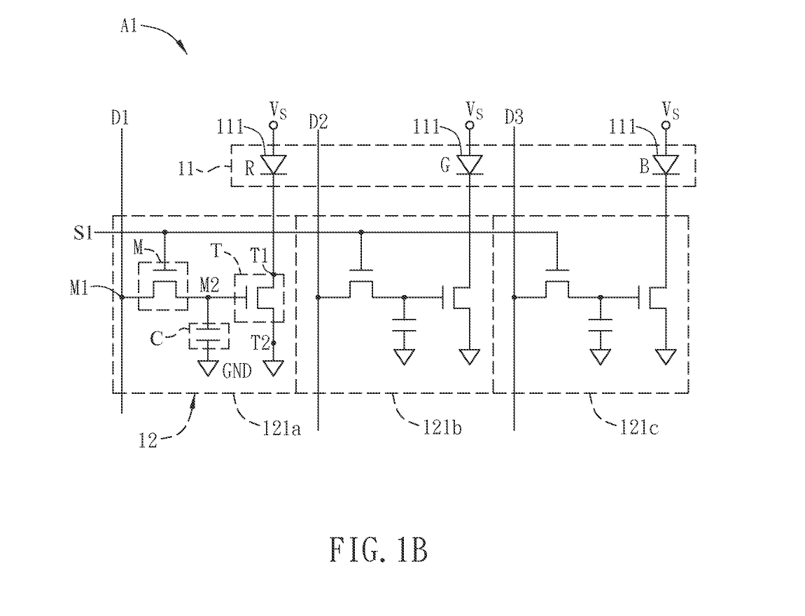

FIG. 1A is a schematic diagram of a display apparatus according to a preferred embodiment of the invention.

As shown in FIG. 1A, the display apparatus 1 includes a substrate, a plurality of data lines, a plurality of scan lines, a plurality of light emitting units 11 and at least a control integrated circuit (IC) chip 12.

The material of the substrate (not shown) can include a transparent material, such as glass, quartz or the like, plastic material, rubber, fiberglass or other polymers. The substrate is preferably an alumino silicate glass substrate. The substrate also can be opaque, and is a metal-fiberglass composite board or metal-ceramic composite board for example. The substrate also can be a flexible substrate, such as an acrylic substrate or a glass substrate with a very small thickness. The data lines and the scan lines cross each other on the substrate to form a plurality of pixels disposed in an array or irregularly. The pixels of this embodiment are disposed in a two dimensional array for example, but otherwise they can be disposed in a one dimensional array like an LED light bar in which the LED units 11 are disposed in a line. In FIG. 1A, although only the pixel on the upper left side is marked by the mark “A1” for conciseness, the other pixels can be considered the same as the pixel A1 and therefore are not marked.

The light emitting units 11 are disposed within a display area D, which is defined herein as the area of the substrate that can display images. Each of the light emitting units 11 can include at least a light emitting diode (LED) chip 111, which can be a die or a packaged LED device for example. The LED chip 111 of each of the light emitting units 11 can have many representations. For example, the light emitting unit 11 can have a single LED chip 111, or some LED chips 111 having different colors (e.g. three chips respectively with red (R), green (G) and blue (B) colors), or four chips with three colors (e.g. R, R, G, B or W (white), R, G, B). However, the invention is not limited thereto.

In this embodiment, each of the light emitting units 11 includes a plurality of LED chips 111 having three colors and connected to each other in parallel. The three colors are red (R), green (G) and blue (B) for example. One end of each of the LED chips 111 is electrically connected to a power V_{S}, and the other end of each of the LED chips 111 is electrically connected to the control IC chip 12.

The control IC chip 12 is disposed within the display area D of the substrate and electrically connected to at least one scan line and at least one data line. Herein for example, the display apparatus 1 includes a plurality of the control IC chips 12, and they are disposed in the pixels of the display area D respectively. The light emitting units 11 can be electrically connected to at least one control IC chip 12, and the control IC chip 12 can be controlled by at least a scan line and receives a data signal through at least a data line to control the light emitting state of the light emitting units 11 according to the data signal.

As shown in FIG. 1A, in this embodiment, the control IC chips 12 are electrically connected to the scan lines (such as the scan line S1 of the pixel A1), data lines (such as the data line D1 of the pixel A1) and light emitting units 11, respectively. The LED chip 111 and the control IC chip 12 can be directly disposed on the substrate by flip chip bonding or wire bonding. To be noted, the LED chip 111 of the invention is inorganic LED, different from the conventional LED made by the thin-film process. Besides, the LED chip 111 (die or packaged LED device) and control IC chip 12 are not disposed on the substrate by flip chip bonding or wire bonding until tested to become the accepted products. Therefore, the substrate can be formed according to the desired shape or size based on the user's requirement. Obviously, in comparison with the conventional display apparatus made by the thin-film process, the display apparatus 1 of the invention can have higher yield and lower production cost.

The circuit of the pixel A1 in FIGS. 1A and 1B will be clearly illustrated as below, and those skilled in the art can comprehend the circuit and control method of other pixels of the display apparatus 1 thereby. FIG. 1B is a schematic diagram of the circuit of a pixel A1 of the display apparatus 1 in FIG. 1A.

In the pixel A1, a control IC chip 12 is electrically connected to a scan line S1, three data lines D1, D2, D3 and three LED chips 111 (R, G, B) of a light emitting unit 11. Each of the data lines D1˜D3 can receive a data signal to control the connected LED chip 111. However, in other embodiments, a control IC chip 12 can be designed to control the LED chips 111 of a plurality of light emitting units 11.

The number of the data lines connected to a control IC chip 12 can be less than or equal to that of the LED chips 111 of the light emitting unit 11 connected to the control IC chip 12. Herein, the number of the data lines (such as the data lines D1˜D3) connected to a control IC chip 12 is equal to that of the LED chips 111 (such as R, G, B) of a light emitting unit 11. Besides, the number of the scan lines connected to a control IC chip 12 can be less than or equal to that of the LED chips 111 of the light emitting unit 11 connected to the control IC chip 12. Herein, the number of the scan lines (such as the scan line S1) connected to a control IC chip 12 is less than that of the LED chips 111 (such as R, G, B) of a light emitting unit 11 but equal to the number (i.e. one) of the light emitting unit 11 in a pixel A1.

In this embodiment, the control IC chip 12 includes three equivalent driving circuits 121a, 121b, 121c respectively driving and controlling the luminous intensities of the three LED chips 111. Herein, each of the driving circuits 121a, 121b, 121c includes at least a switch transistor M, a driving transistor T and a capacitance C.

Each of the driving circuits 121a, 121b, 121c in FIG. 1B is a “2T1C” circuit structure. However, they can be other circuit structures, such as “4T2C” or “5T1C”.

In the driving circuit 121a, the gate of the switch transistor M is connected to the scan line S1 that is connected to the control IC chip 12, the first end M1 of the switch transistor M is connected to the data line D1 that is connected to the driving circuit 121a, and the second end M2 of the switch transistor M is connected to the gate of the driving transistor T and one end of the capacitance C. Besides, the first end T1 of the driving transistor T is connected to the LED chip (R) 111 of the light emitting unit 11 that is connected to the driving circuit 121a, and the second end T2 of the driving transistor T and the second end of the capacitance C are both grounded. Herein, the driving circuit 121a of the control IC chip 12 is the current control circuit of the LED chip 111 of the light emitting unit 11. When the scan line S1 is enabled, a data signal is transmitted through the data line D1 to control the luminous intensity of the LED chip (R) 111 that is connected to the first end T1 of the driving transistor T. Likewise, another data signal can be transmitted through the data line D2 to control the luminous intensity of the LED chip (G) 111, and another data signal can be transmitted through the data line D3 to control the luminous intensity of the LED chip (B) 111. Accordingly, when the scan line S1 enables the switch transistor M, the data signal of the data line D1 can be inputted to the gate of the driving transistor T through the switch transistor M to control the turn-on or turn-off of the driving transistor T and thus to control the luminous intensity of the LED chip 111. Herein, the data signal can be an analog signal or digital signal.

Accordingly, in the display apparatus 1 of the invention, the luminous states of the light emitting units 11 can be controlled according to the data signals by enabling the scan lines and controlling the control IC chips to receive the signals of the scan lines and the data signals of the data lines. The control IC chips 12 can control the duty cycles or current levels applied to the light emitting units 11 to control the luminous intensities of the LED chips 111 of the light emitting units 11. In other words, the control IC chip 12 can control the enabling time or current of the LED chip 111 applied to the light emitting unit 11 to control the luminous intensity of the LED chip 111.

To be noted, the display apparatus 1 of the invention is an active matrix LED (AMLED) display apparatus where the capacitance C is used to keep the voltage of the data signal of the data line (the voltage kept by the capacitance C will not change until the scan line is enabled in the next frame time), so the duty cycle of each of the scan line can approximate 100%.

The display apparatus 1 can further include a plurality of sensing devices (not shown), which can be electrically connected to the control IC chips 12 respectively. Otherwise, each of the control IC chips 12 can include at least a sensing device (not shown). Whether included by the display apparatus 1 or by the control IC chip 12, the sensing device can be a photo sensing device. The photo sensing device can receive a photo signal (such as infrared light or laser beam), and then the control IC chip 12 generates a sensing signal accordingly for the positioning or control purpose for the screen for example.

For some examples, the photo signal received by the photo sensing device comes from an external light emitter (such as a laser pen or other emitters), or comes from the light that is emitted from the display apparatus 1 and then reflected by an external object (such as a finger, touch pen or other objects), or comes from the light emitted by a light emitting device (not shown) of the display apparatus 1, or comes from an external light that is blocked by an external object (such as a finger, touch pen or other objects). The light emitting device of the display apparatus 1 can be an LED, and can be controlled by the scan line or control IC chip 12 to emit, for example, invisible light (e.g. infrared light or ultraviolet).

When the photo sensing device receives the photo signal, the control IC chip 12 can emit a sensing signal. Thereby, the control IC chip 12 is used as a photo touch sensor to be applied to the following positioning and control functions. The photo signal can be a modulation signal (such as PWM signal) so that it can be distinguishable from the environmental light or the light emitted by the LED chip 111 of the light emitting unit 11 for decreasing the erroneous judgment of the sensing when the photo sensing device receives the photo signal. In another case, the photo sensing device can sense the change of the luminous intensity of the LED chip 111 of the light emitting unit 11 electrically connected to the control IC chip 12, and thereby the driving current can be raised or an alarm signal can be emitted under the control of the control IC chip 12 for modifying the luminous intensity of the LED chip 111, for example, when the decrease of the luminous intensity of the LED chip 111 exceeds a certain degree.

When the above-mentioned sensing device is an electric sensing device, it can receive an electric signal and the control IC chip 12 can generate another sensing signal accordingly. The electric signal can come from an external electric signal emitter (such as the touch pen capable of causing current), or come from the electric signal that is emitted by the display apparatus 1 and then coupled by an external object (such as the user's finger approaching). Thereby, the control IC chip 12 is used as a touch sensor of electric signal to be applied to the following positioning and control functions.

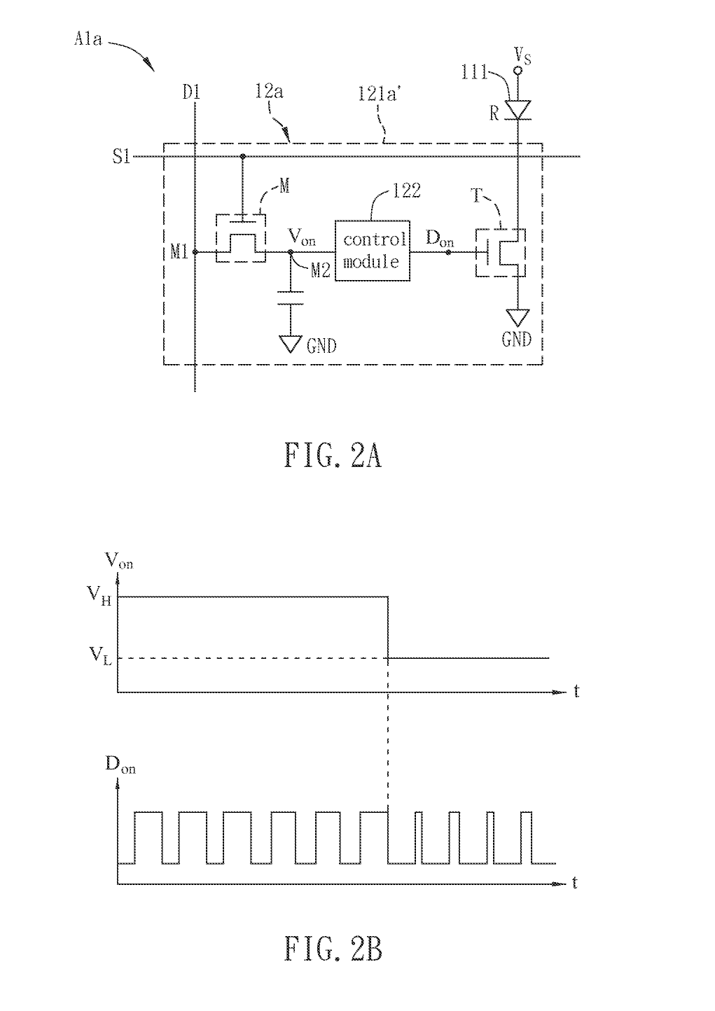

FIG. 2A is a schematic diagram of a driving circuit 121a′ of a pixel A1a of the display apparatus 1 as another embodiment of the invention, and FIG. 2B is a schematic diagram showing the signal in FIG. 2A. Herein, FIG. 2A just shows the driving circuit 121a′ and the LED chip 111 (R) of the pixel A1a, not showing the driving circuits 121b′ and 121c′, and the driving circuits 121b′ and 121c′ are the same as the driving circuit 121a′.

Mainly different from the control IC chip 12, the driving circuit 121a′ of the control IC chip 12a in FIG. 2A further includes a control module 122, which is electrically connected to the second end M2 (the voltage thereof is represented by V_{ON}) of the switch transistor M and the gate (the voltage thereof is represented by D_{ON}) of the driving transistor T. During the enabling time of the scan line S1, the control module 12 can receive the data signal on the data line D1, so the signal of the second end M2 of the switch transistor M is the same as the data signal (i.e. V_{ON}). After the processing of the control module 122, the control signal (i.e. D_{ON}) can be generated to be inputted to the gate of the driving transistor T for controlling the duty cycle and luminous intensity of the LED chip 111.

As shown in FIG. 2B, the data signal is a digital signal, but it can be an analog signal otherwise. When the voltage V_{ON} of the second end M2 of the switch transistor M is high voltage V_{H}, the voltage D_{ON} inputted to the gate of the driving transistor T can have greater duty cycle under the processing of the control module 122 (that means the enabling time of the driving transistor T is longer, so that the LED chip 111 has greater luminous intensity). When the voltage V_{ON} of the second end M2 of the switch transistor M is low voltage V_{L}, the voltage D_{ON} inputted to the gate of the driving transistor T can have less duty cycle under the processing of the control module 122 (that means the enabling time of the driving transistor T is shorter, so that the LED chip 111 has less luminous intensity). Therefore, by the controlling of the control module 122, the driving circuit 121a′ can control the enabling time of the LED chip 111 according to the inputted voltage (i.e. the voltage of the data signal) to cause the gray level corresponding to the data signal. Of course, in other embodiments, the enabling time of the LED chip 111 can be made shorter when the voltage V_{ON} of the second end M2 of the switch transistor M is high voltage V_{H} while the enabling time of the LED chip 111 can be made longer when the voltage V_{ON} of the second end M2 of the switch transistor M is low voltage V_{L}.

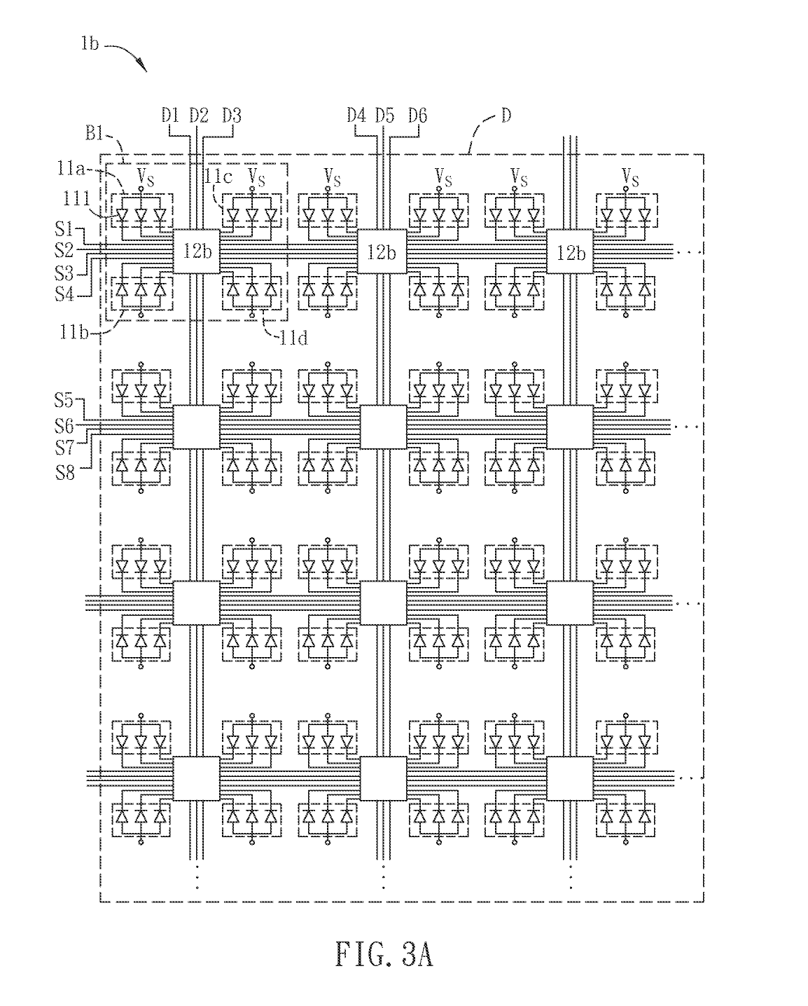

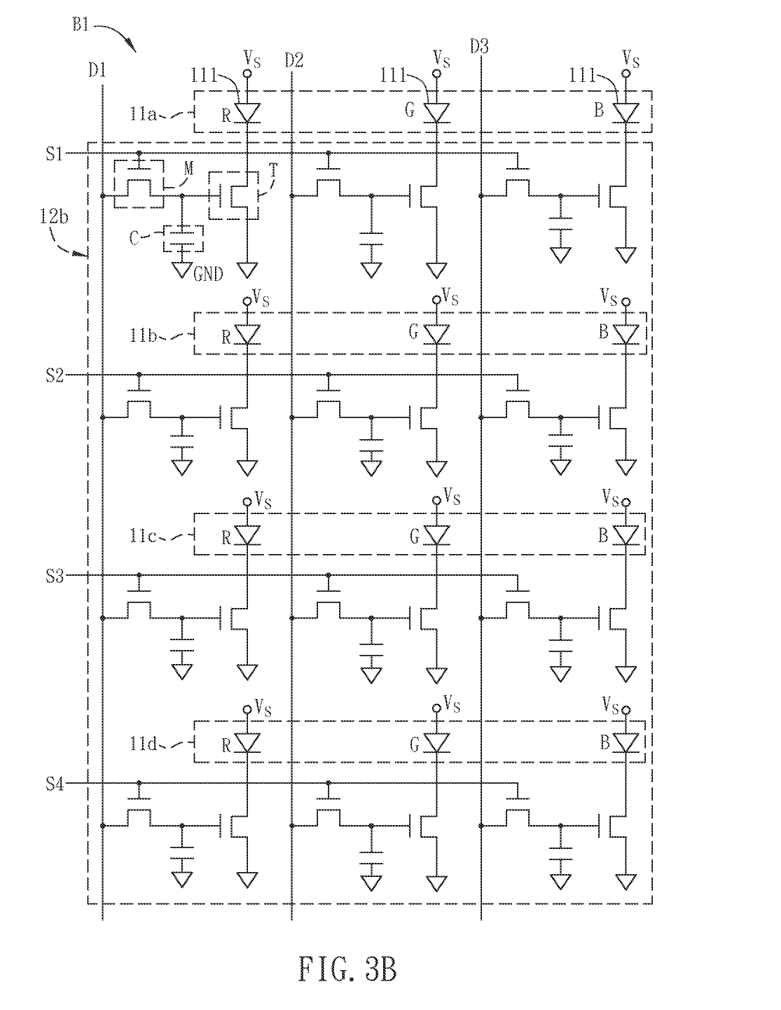

FIG. 3A is a schematic diagram of a display apparatus 1b according to another embodiment of the invention, and FIG. 3B is a schematic diagram showing the circuit of a pixel B1 of the display apparatus 1b in FIG. 3A. In FIG. 3A, although only the pixel on the upper left side is marked by the mark “B1” for conciseness, the other pixels can be considered the same as the pixel B1 and therefore are not marked.

As shown in FIGS. 3A and 3B, mainly different from the display apparatus 1, the control IC chip 12b of the display apparatus 1b is electrically connected to four scan lines, three data lines and four light emitting units 11a, 11b, 11c, 11d. In FIG. 3B, the scan line S1 can control the light emitting unit 11a, the scan line S2 can control the light emitting unit 11b, the scan line S3 can control the light emitting unit 11c, and the scan line S4 can control the light emitting unit 11d. Herein, the number of the data lines (such as the data liens D1˜D3) connected to a control IC chip 12b is equal to that of the LED chips 111 of the light emitting unit 11a connected to the control IC chip 12b (the number is 3 for example). Besides, the number of the scan lines (such as the scan liens S1˜S4) connected to a control IC chip 12b is less than that of the LED chips 111 of the light emitting unit 11a˜11d (3*4=12) connected to the control IC chip 12b, but equal to that of the all light emitting units 11a˜11d connected to the control IC chip 12b. Moreover, the data lines D1˜D3 can control the luminous intensities of the respective LED chips 111 (R, G, B) of the light emitting units 11a˜11d.

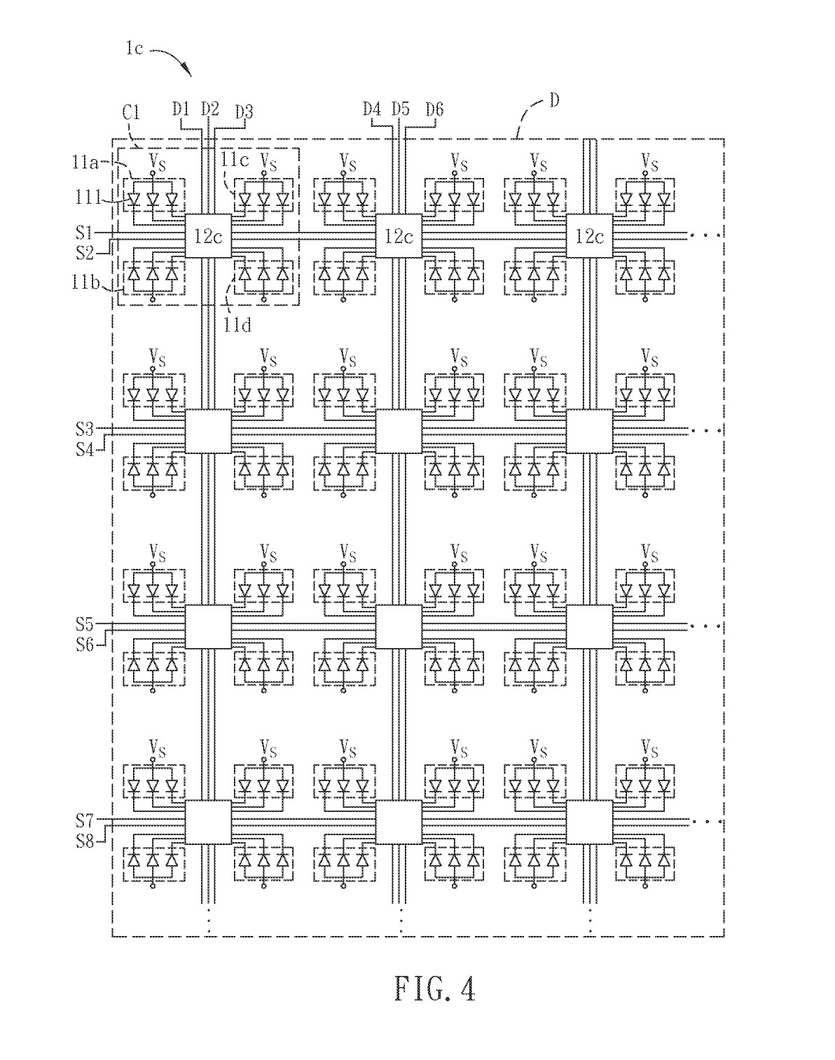

FIG. 4 is a schematic diagram of a display apparatus 1c according to another embodiment of the invention.

As shown in FIG. 4, mainly different from the display apparatus 1b, the control IC chip 12c of the display apparatus 1c is electrically connected to two scan lines. Besides, the control IC chip 12c of the display apparatus 1c includes a decoder (not shown), which is electrically connected to the scan lines connected to the control IC chip 12c. Because the number of the scan lines connected to a control IC chip 12c is two, the four addresses can be generated by the decoder to respectively control the adjacent four light emitting units 11a˜11d. Therefore, the number of the scan lines connected to the control IC chip 12c is decreased by the configuration of the decoder.

Other technical features of the display apparatuses 1b and 1c can be comprehended by referring to the same components of the display apparatus 1, and therefore they are not described here for conciseness.

In summary, in the display apparatus according to the invention, the light emitting units are electrically connected to at least a control IC chip, and the control IC chip is controlled by at least a scan line and receives a data signal from at least a data line to control the luminous states of the light emitting units according to the data signal. Thereby, in comparison with the prior art, the control IC chip and light emitting units of the invention are disposed on the substrate instead of being formed by the thin-film process, so the display apparatus of the invention can have higher yield and less production cost.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A display apparatus, comprising:
a substrate;
a plurality of scan lines;
a plurality of data lines crossing the scan lines on the substrate;
a plurality of light emitting units disposed in a display area of the substrate; and
at least a control integrated circuit (IC) chip disposed within the display area of the substrate and electrically connected to at least one of the scan lines and at least one of the data lines;
wherein the light emitting units are electrically connected to at least one of the control IC chip, which is controlled by at least one of the scan lines and receives a data signal from at least one of the data lines to control the luminous states of the light emitting units according to the data signal.

2. The display apparatus as recited in claim 1, wherein each of the light emitting units includes at least a light emitting diode (LED) chip.

3. The display apparatus as recited in claim 2, wherein each of the LED chip and the control IC chip is disposed on the substrate by flip chip bonding or wire bonding.

4. The display apparatus as recited in claim 2, wherein the number of the data lines connected to the control IC chip is less than or equal to that of the LED chips of the light emitting unit connected to the control IC chip.

5. The display apparatus as recited in claim 2, wherein the number of the scan lines connected to the control IC chip is less than or equal to that of the LED chips of the light emitting unit connected to the control IC chip.

6. The display apparatus as recited in claim 1, wherein the control IC chip includes a decoder, which is electrically connected to the scan lines connected to the control IC chip.

7. The display apparatus as recited in claim 1, further comprising:
a plurality of sensing devices electrically connected to the control IC chip.

8. The display apparatus as recited in claim 7, wherein the sensing device is a photo sensing device receiving a photo signal, and the control IC chip generates a sensing signal accordingly.

9. The display apparatus as recited in claim 8, wherein the photo signal comes from an external light emitter, or comes from the light that is emitted by the display apparatus and then reflected by an external object, or comes from the light emitted by a light emitting device of the display apparatus, or comes from an external light that is blocked by an external object.

10. The display apparatus as recited in claim 9, wherein the light emitting device is an LED emitting invisible light.

11. The display apparatus as recited in claim 7, wherein the sensing device is an electric sensing device to receive an electric signal and the control IC chip generates a sensing signal accordingly.

12. The display apparatus as recited in claim 11, wherein the electric signal comes from an external electric signal emitter, or comes from the electric signal that is emitted by the display apparatus and then coupled by an external object.

13. The display apparatus as recited in claim 1, wherein the control IC chip includes at least a sensing device.

14. The display apparatus as recited in claim 13, wherein the sensing device is a photo sensing device receiving a photo signal, and the control IC chip generates a sensing signal accordingly.

15. The display apparatus as recited in claim 14, wherein the photo signal comes from an external light emitter, or comes from the light that is emitted by the display apparatus and then reflected by an external object, or comes from the light emitted by a light emitting device of the display apparatus, or comes from an external light that is blocked by an external object.

16. The display apparatus as recited in claim 15, wherein the light emitting device is an LED emitting invisible light.

17. The display apparatus as recited in claim 13, wherein the sensing device is an electric sensing device to receive an electric signal and the control IC chip generates a sensing signal accordingly.

18. The display apparatus as recited in claim 17, wherein the electric signal comes from an external electric signal emitter, or comes from the electric signal that is emitted by the display apparatus and then coupled by an external object.

19. The display apparatus as recited in claim 1, wherein the control IC chip controls the duty cycles or current levels of the light emitting units to control their luminous intensities.
